(19) United States
(12) Patent Application Publication
(10) Pub. No.: US 2016/0276644 A1
(43) Pub. Date: Sep. 22, 2016

(54) Patch board and lithium-ion battery pack using the same

(71) Applicant: SHENZHEN GREPOW BATTERY CO. LTD, Shenzhen City, Guangdong (CN)

(72) Inventors: An Hsuan Ho, Shenzhen (CN); Xinrong Tang, Shenzhen (CN); Bing Guo, Shenzhen (CN)

(73) Assignee: Shenzhen Grepow Battery Co., Ltd., Shenzhen (CN)

(21) Appl. No.: 14/648,201

(22) PCT Filed: Mar. 13, 2014
(86) PCT No.: PCT/CN2014/073414

§ 371 Date: May 28, 2015

(51) Int. Cl. H01M 2/22; H01M 2/10; H01M 10/0525

(52) U.S. Cl. CPC H01M 2/22; H01M 10/0525; H01M 2/1077; H01M 2220/20

(57) ABSTRACT

The present invention directs a patch board and a lithium-ion battery pack using the same. The patch board comprising: an insulation substrate, wherein a first tab through-hole and a second tab through-hole for tabs which are cutting through thereon are respectively provided on the insulation substrate; and further comprising: a first metal component, a second metal component and a third metal component, which are fixed on the surface of the insulation substrate; the first metal component comprising a first metal tube and a first metal plate extended at the right side of the first metal tube, the second metal component comprising a second metal tube, a second metal plate and a third metal plate which are respectively extended at the both left and right sides of the second metal tube, the third metal component comprising a third metal tube and a fourth metal plate extended at the right side of the third metal tube; the first metal plate and the second metal plate are facing and parallel to each other, which are respectively located at the front and back sides of the first tab through-hole, and the third metal plate and the fourth metal plate are acing and parallel to each other, which are respectively located at the front and back sides of the second tab through-hole. The patch board according to the present invention is beneficial to improve the cycle performance of the battery pack.

### FIELD OF THE INVENTION

The present invention relates to a technical area of lithium-ion battery, particularly to a patch board and lithium-ion battery pack.

### BACKGROUND OF THE INVENTION

The lithium-ion battery is widely used as a new energy battery with the characteristic of environmental protection and energy saving. At present, the patch board which is used for the serial connection of lithium-ion battery in a vehicle model is made of a fireboard covered with copper foil. When a high current is passing through the battery, the internal resistance of the battery will be higher with a large heat, and whose discharge performance will be poor.

### SUMMARY OF THE INVENTION

An object of the embodiment according to the present invention is to provide a patch board and a lithium-ion battery pack using the same, which are beneficial to improve the cycle performance of the lithium-ion battery pack in series during high current discharge.

The patch board provided by the embodiment of the present invention, for lithium-ion battery pack, comprising: an insulation substrate;

wherein a first tab through-hole and a second tab through-hole for tabs which are cutting through thereon are respectively provided on the insulation substrate;

further comprising: a first metal component, a second metal component and a third metal component, which are fixed on the surface of the insulation substrate;

the first metal component comprising a first metal tube and a first metal plate extended at the right side of the first metal tube,

the second metal component comprising a second metal tube, a second metal plate and a third metal plate which are respectively extended at the both left and right sides of the second metal tube,

the third metal component comprising a third metal tube and a fourth metal plate extended at the right side of the third metal tube,

wherein the first metal plate and the second metal plate are facing and parallel to each other, which are respectively located at the front and back sides of the first tab through-hole, and

the third metal plate and the fourth metal plate are facing and parallel to each other, which are respectively located at the front and back sides of the second tab through-hole.

Optionally, a protruded insulation spacing board is provided between the first metal tube and the second metal plate.

Optionally, a protruded insulation spacing board is provided between the first metal plate and the second metal tube.

Optionally, a protruded insulation spacing board is provided between the fourth metal plate and the second metal tube.

Optionally, a protruded insulation spacing board is provided between the third metal plate and the third metal tube.

A lithium-ion battery pack provided by the embodiment of the present invention, comprising: a lithium-ion cell pack which is composed of at least two battery monomers, wherein an anode tab and a cathode tab are respectively extended out from the top of each battery monomer, which is characterized in:

further comprising a patch board according to any of above description,

for any one of first battery monomer and second battery monomer which are series connection, an anode tab of the first battery monomer and a cathode tab of the second battery monomer are respectively extended out from the first tab through-hole, the anode tab of the first battery monomer is bent and welded on the top surface of the second metal plate, and the cathode tab of the second battery monomer is bent and welded on the top surface of the first metal plate,

a cathode tab of the first battery monomer and an anode tab of the second battery monomer are respectively extended out from the second tab through-hole, the cathode tab of the first battery monomer is bent and welded on the top surface of the fourth metal plate, and the anode tab of the third battery monomer is bent and welded on the top surface of the third metal plate.

As described in above, applying the technical solution of the embodiment according to the present invention, when series connecting the battery monomers, it is only required to fix each tab of battery monomers on such four metal plates respectively by use of the patch board of the present invention, without any other lead or wire to present the interconnection of series spots, so that the assembly of battery pack is simple, convenient, and easy to operate in relative to the prior art. In addition, the metal component is used for series connection of the patch board in the embodiment of the present invention, in relative to the lead or circuit board routing connection, it is beneficial to reduce the series resistance of battery pack, lower the discharge temperature, and avoid the output disconnection problem since the temperature of series spot is excess, and then improve the cycle performance of the battery pack when it is discharging in a high current.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the patch board according to the first embodiment of the present invention;

FIG. 2 is a stereostructure view of the patch board from another angle according to FIG. 1:

FIG. 3 is a schematic view of an assembled structure of the patch board according to FIG. 1;

FIG. 4 is a contrast diagram showing the changing curves of discharge capacity of the battery in 150A according to the first embodiment of the present invention:

FIG. 5 is a variation diagram showing the temperature changing curves of the battery during discharging in 150A according to the first embodiment of the present invention.

### FIGURE REFERENCE

100: insulation substrate, 101: first metal component; 102: second metal component; 103: third metal component; 1001: first tab through-hole; 1002: second tab through-hole; 1011: first metal tube; 1012: first metal plate; 1021: second metal tube; 1022: second metal plate; 1023: third metal plate; 1032: fourth metal plate; 1003: insulation spacing board.

### DETAILED DESCRIPTION OF ILLUSTRATED EMBODIMENTS

Various preferred embodiments of the invention will now be described with reference to the figures, wherein like reference numerals designate similar parts throughout the various views.

### Embodiment 1

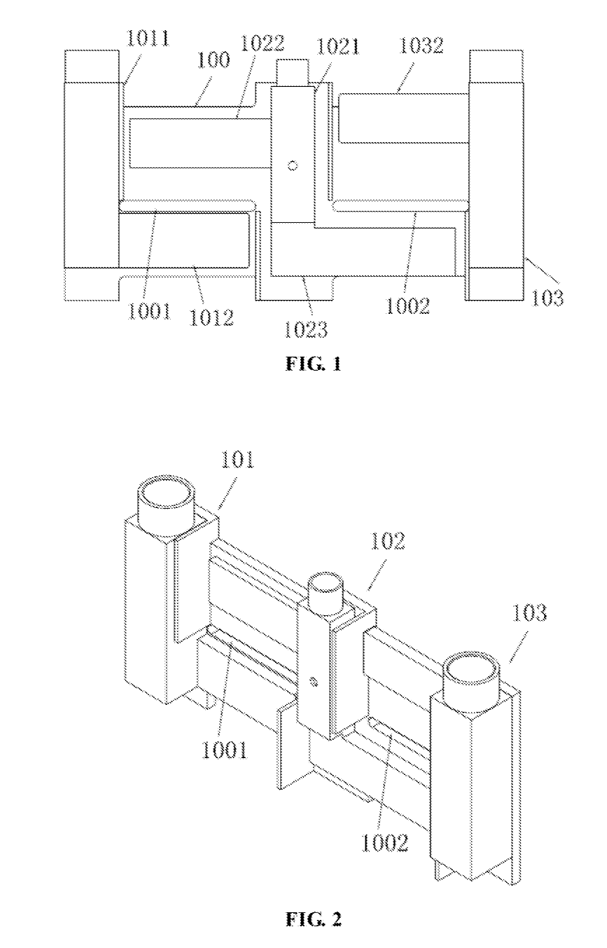

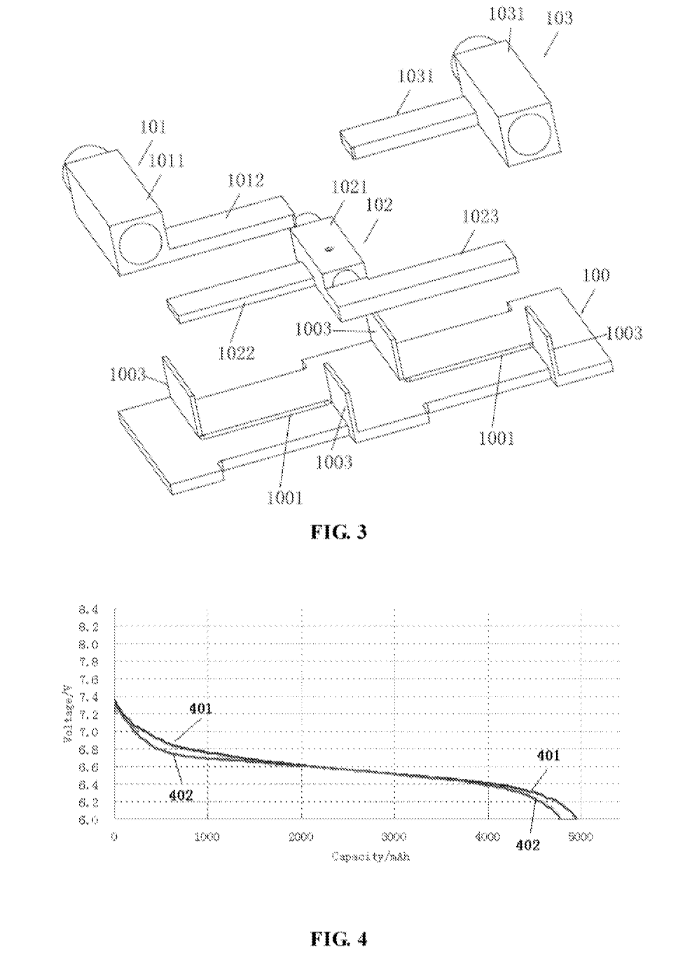

As shown in FIGS. 1-3, a patch board for lithium-ion battery pack according to the present invention comprises an insulation substrate 100; and a first metal component 101, a second metal component 102, and a third metal component 103 which are fixed on the insulation substrate 100.

A first tab through-hole 1001 and a second tab through-hole 1002 for the tabs which are cutting through thereon are respectively arranged on the insulation substrate 100.

The first metal component 101 comprising a first metal tube 1011 and a first metal plate 1012 extended at the right side of the first metal tube 1011. The second metal component 102 comprising a second metal tube 1021, a second metal plate 1022 and a third metal plate 1023 which are extended at both left and right sides of the second metal tube 1021. The third metal component 103 comprising a third metal tube 1031 and a fourth metal plate 1032 extended at the right side of the third metal tube 1031.

When being fixed on the top of insulation substrate 100, the first, second and third metal tubes 1011, 1021, and 1031 are parallel to each other. The first metal plate 1012 and the second metal plate 1022 between the first metal tube 1011 and the second metal tube 1021 are facing and parallel to each other with a space between thereof which are positioned at the front and back sides of the first tab through-hole 1001. Similarly, the third metal plate 1023 and the fourth metal plate 1032 between the second metal tube 1021 and the third metal tube 1031 are facing and parallel to each other with a space between thereof, which are positioned at the front and back sides of the second tab through-hole 1002.

The patch board of the present invention can be further applied to an assembly of the lithium-ion battery pack which is composed of a plurality of lithium-ion battery monomers in series:

The connection relationship between the patch board and battery monomer will be illustrated by any two adjacent battery monomers (recorded as a first battery monomer and a second battery monomer).

An anode tab of the first battery monomer and a cathode tab of the second battery monomer are respectively extended out from the first tab through-hole 1001 of the insulation substrate 100; the anode tab of the first battery monomer is fixed on the top surface of the second metal plate 1022 via an electrical connection (welding, laser spot welding or the like), and the cathode tab of the second battery monomer is bent and fixed on the top surface of the first metal plate 1012 via the electrical connection. Similarly, the cathode tab of the first battery monomer and the anode tab of the second battery monomer are respectively extended out from the second tab through-hole 1002 of the insulation substrate 100; the cathode tab of the first battery monomer is fixed on the top surface of the fourth metal plate 1032 via the electrical connection, and the cathode tab of the second battery monomer is fixed on the top surface of the third metal plate 1023 via the electrical connection. In such way, the first battery monomer and the second battery monomer are connected together in series via the first metal component 101, second first metal component 102 and the third metal component 103.

As the above description, applying the technical solution of the embodiment according to the present invention, when presenting the series connection of the battery monomers, it is only required to fix each tab of the battery monomers on such four metal plates respectively by use of the patch board of the present invention, without any other lead or wire to present the interconnection of series spots, so that the assembly of battery pack is simple, convenient, and easy to operate in relative to the prior art. In addition, the metal component is used for series connection of the patch board in the embodiment of the present invention, in relative to the lead or circuit board routing connection, it is beneficial to reduce the series resistance of battery pack, lower the discharge temperature, and avoid the output disconnection problem since the temperature of series spot is excess, and then improve the cycle performance of the battery pack when it is discharging in a high current.

As an example of the embodiment, a protruded insulation spacing board 1003 may be further arranged between the first metal tube 1011 and the second metal plate 1022, the first metal plate 1012 and the second metal tube 1021, the fourth metal plate 1032 and the second metal tube 1021, the third metal plate 1023 and the third metal tube 1031. In order to improve the insulation performance of each series spot and avoid short circuit, the insulation spacing board 1003 may be but not limited to an integration design with the insulation substrate 100, which is integrated shaped during the molding of the insulation substrate 100.

As an example of the embodiment, the insulation substrate 100 can be but not limited to bakelite plate, or plastic plate, or the like insulation materials substrate.

As an example of the embodiment, the first metal tube 1011 and the third metal tube 1031 may be for the external power supply as an anode or cathode output terminal of the lithium-ion battery pack according to the embodiment. The first metal component 101, the second metal component 102 and the third metal component 103 are the series connection parts of the battery monomers according to the embodiment.

As an example of the embodiment, except to be used as the series connection parts of the battery monomers, the second metal tube 1031 on the second metal component 102 can be taken as a connection interface of a node for detecting the charging voltage during this lithium-ion battery is charging, so as to provide for detecting of battery charging, further to improve the convenience of the battery use and simplify the structure.

For purpose of illustrating the technical advantages of the embodiment, a further analysis of the embodiment is given according to the experimental data.

The testing object listed below is lithium-ion battery as a type of APA742126-Q2A-7.4V, and the standard capacity is 5200 mAh.

Control group: a traditional PCB patch board, and the series welding connection of lithium-ion battery pack is processed via a copper foil routing on the traditional PCB patch board.

The present invention: the patch board of the present invention is used to present the series connection.

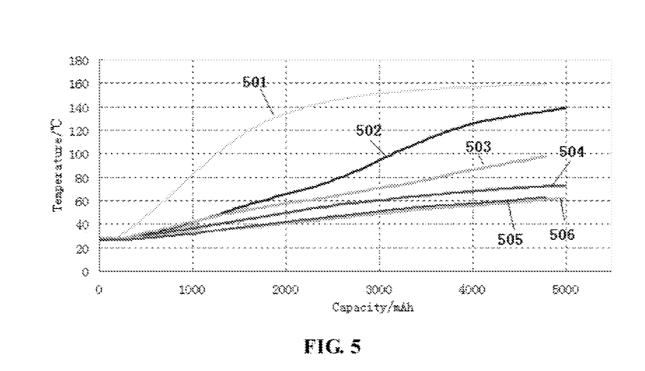

Test 1: testing the discharge performance of the battery pack in 150A, and the experimental data (as shown in Table. 1) and schematic view (as shown in FIG. 4) of the changing curve of discharge capacity are given as below. In FIG. 4, 401 is a changing curve of discharge capacity according to the battery of present invention, and 402 is a changing curve of discharge capacity according to the battery of control group.

Test 2: After charging the battery pack in IC, the battery pack is constant-current discharged to 6.0V in 150A, and then recording the discharge capacity, temperature of copper tube, temperature of series spot, and the surface temperature of the battery pack. In FIG. 5, 501 is a changing curve of the temperature at the centre of the first metal tube according to the battery of control group, 502 is a changing curve the temperature at the centre of the first metal tube according to the battery of present invention, 503 is a temperature changing curve of the series spot at the surface of the second metal component according to the battery of control group, 504 is a temperature changing curve of the series spot at the surface of the second metal component according to the battery of present invention, 505 is a changing curve of the temperature at the case surface according to the battery pack of control group, and 506 is a changing curve of the temperature at the case surface according to the battery pack of present invention.

Test equipment: testing cabinet.

TABLE 1
Testing data of the discharge performance in 150A

| | | | | | | Surface | |
|---|---|---|---|---|---|---|---|
| | Internal | Discharge | Mean | Temperature | Temperature | Temperature | |
| | Resistance | Capacity | Voltage | of Copper | of Series | of Battery | |
| No. | (mΩ) | (mAh) | (V) | Tube (□) | Spot (□) | (□) | Appearance |
| Control | 8.7 | 4792.3 | 6.565 | 158.6 | 97.6 | 63 | Tiny |
| Group | | | | | | | gas expansion, |
| | | | | | | | which is |
| | | | | | | | recoverable |
| Present | 8.0 | 5000.6 | 6.561 | 138.7 | 72.7 | 61.8 | No change |
| Invention | | | | | | | |
| Balance | 0.7 | −208 | 0.004 | 19.9 | 24.9 | 1.2 | |

According to Table. 1, FIGS. 4 and 5, using the patch board of the present invention, it is beneficial to improve the cycle performance of lithium-ion battery during high-rate discharge, and greatly reduce the temperature of series spot, particularly for a high-power lithium-ion battery pack.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A patch board for lithium-ion battery pack, comprising:
an insulation substrate, wherein a first tab through-hole and a second tab through-hole for tabs which are cutting through thereon are respectively provided on the insulation substrate;
further comprising: a first metal component, a second metal component and a third metal component, which are fixed on the surface of the insulation substrate;
the first metal component comprising a first metal tube and a first metal plate extended at the right side of the first metal tube,
the second metal component comprising a second metal tube, a second metal plate and a third metal plate which are respectively extended at the both left and right sides of the second metal tube,
the third metal component comprising a third metal tube and a fourth metal plate extended at the right side of the third metal tube,
wherein the first metal plate and the second metal plate are facing and parallel to each other, which are respectively located at the front and back sides of the first tab through-hole, and
the third metal plate and the fourth metal plate are facing and parallel to each other, which are respectively located at the front and back sides of the second tab through-hole.

2. The patch board according to claim 1, wherein a protruded insulation spacing board is provided between the first metal tube and the second metal plate.

3. The patch board according to claim 1, wherein a protruded insulation spacing board is provided between the first metal plate and the second metal tube.

4. The patch board according to claim 1, wherein a protruded insulation spacing board is provided between the fourth metal plate and the second metal tube.

5. The patch board according to claim 1, wherein a protruded insulation spacing board is provided between the third metal plate and the third metal tube.

6. A lithium-ion battery pack, comprising: a lithium-ion cell pack which is composed of at least two battery monomers, wherein an anode tab and a cathode tab are respectively extended out from the top of each battery monomer, which is characterized in:
further comprising a patch board according to claim 1,
for any one of first battery monomer and second battery monomer which are series connection, an anode tab of the first battery monomer and a cathode tab of the second battery monomer are respectively extended out from the first tab through-hole, the anode tab of the first battery monomer is bent and welded on the top surface of the second metal plate, and the cathode tab of the second battery monomer is bent and welded on the top surface of the first metal plate,
a cathode tab of the first battery monomer and an anode tab of the second battery monomer are respectively extended out from the second tab through-hole, the cathode tab of the first battery monomer is bent and welded on the top surface of the fourth metal plate, and the anode tab of the third battery monomer is bent and welded on the top surface of the third metal plate.

7. A lithium-ion battery pack, comprising: a lithium-ion cell pack which is composed of at least two battery monomers, wherein an anode tab and a cathode tab are respectively extended out from the top of each battery monomer, which is characterized in:
further comprising a patch board according to claim 2,
for any one of first battery monomer and second battery monomer which are series connection, an anode tab of the first battery monomer and a cathode tab of the second battery monomer are respectively extended out from the first tab through-hole, the anode tab of the first battery monomer is bent and welded on the top surface of the second metal plate, and the cathode tab of the second battery monomer is bent and welded on the top surface of the first metal plate,
a cathode tab of the first battery monomer and an anode tab of the second battery monomer are respectively extended out from the second tab through-hole, the cathode tab of the first battery monomer is bent and welded on the top surface of the fourth metal plate, and the anode tab of the third battery monomer is bent and welded on the top surface of the third metal plate.

8. A lithium-ion battery pack, comprising: a lithium-ion cell pack which is composed of at least two battery monomers, wherein an anode tab and a cathode tab are respectively extended out from the top of each battery monomer, which is characterized in:
further comprising a patch board according to claim 3,
for any one of first battery monomer and second battery monomer which are series connection, an anode tab of the first battery monomer and a cathode tab of the second battery monomer are respectively extended out from the first tab through-hole, the anode tab of the first battery monomer is bent and welded on the top surface of the second metal plate, and the cathode tab of the second battery monomer is bent and welded on the top surface of the first metal plate,
a cathode tab of the first battery monomer and an anode tab of the second battery monomer are respectively extended out from the second tab through-hole, the cathode tab of the first battery monomer is bent and welded on the top surface of the fourth metal plate, and the anode tab of the third battery monomer is bent and welded on the top surface of the third metal plate.

9. A lithium-ion battery pack, comprising: a lithium-ion cell pack which is composed of at least two battery monomers, wherein an anode tab and a cathode tab are respectively extended out from the top of each battery monomer, which is characterized in:
further comprising a patch board according to claim 4,
for any one of first battery monomer and second battery monomer which are series connection, an anode tab of the first battery monomer and a cathode tab of the second battery monomer are respectively extended out from the first tab through-hole, the anode tab of the first battery monomer is bent and welded on the top surface of the second metal plate, and the cathode tab of the second battery monomer is bent and welded on the top surface of the first metal plate,
a cathode tab of the first battery monomer and an anode tab of the second battery monomer are respectively extended out from the second tab through-hole, the cathode tab of the first battery monomer is bent and welded on the top surface of the fourth metal plate, and the anode tab of the third battery monomer is bent and welded on the top surface of the third metal plate.

10. A lithium-ion battery pack, comprising: a lithium-ion cell pack which is composed of at least two battery monomers, wherein an anode tab and a cathode tab are respectively extended out from the top of each battery monomer, which is characterized in:
further comprising a patch board according to claim 5,
for any one of first battery monomer and second battery monomer which are series connection, an anode tab of the first battery monomer and a cathode tab of the second battery monomer are respectively extended out from the first tab through-hole, the anode tab of the first battery monomer is bent and welded on the top surface of the second metal plate, and the cathode tab of the second battery monomer is bent and welded on the top surface of the first metal plate,
a cathode tab of the first battery monomer and an anode tab of the second battery monomer are respectively extended out from the second tab through-hole, the cathode tab of the first battery monomer is bent and welded on the top surface of the fourth metal plate, and the anode tab of the third battery monomer is bent and welded on the top surface of the third metal plate.
